(19) United States
(12) Patent Application Publication
(10) Pub. No.: US 2021/0266252 A1
(43) Pub. Date: Aug. 26, 2021

(54) Method and Router for Translation of Link State Advertisement

(71) Applicant: Telefonaktiebolaget LM Ericsson (PUBL), Stockholm (SE)

(72) Inventors: Chao FU, Beijing (CN); Shaohong KANG, Beijing (CN); Junjie Jl, Beijing (CN); Wei XU, Beijing (CN); Hui YUAN, BEIJING (CN)

(21) Appl. No.: 16/973,835

(22) PCT Filed: Oct. 15, 2018
(86) PCT No.: PCT/CN2018/110237

§ 371 Date: Dec. 10, 2020

(51) Int. Cl. H04L 12/723; H04L 12/715; H04L 12/751; H04L 12/721; H04L 12/46

(52) U.S. Cl. CPC H04L 45/50; H04L 45/04; H04L 12/4641; H04L 45/12; H04L 45/02

(57) ABSTRACT

The present disclosure provides a method (300) in a Customer's Edge (CE) router for translation of Link State Advertisement (LSA). The CE router is provided at a border of an Open Shortest Path First (OSPF) Not-So-Stubby Area (NSSA). The method (300) includes: receiving (310) from a Provider's Edge, PE, router a Type-7 LSA containing an address prefix and an LSA option set to prevent any other PE routers receiving the address prefix from using it for route calculation; translating (320) the Type-7 LSA into a Type-5 LSA and setting the LSA option in the Type-5 LSA; and transmitting (330) the Type-5 LSA to a first router external to the NSSA.

### TECHNICAL FIELD

The present disclosure relates to communication technology, and more particularly, to a method and a router for translation of Link State Advertisement (LSA).

### BACKGROUND

Internet Engineering Task Force (IETF) Request For Comments (RFC) 4364, BGP/MPLS IP Virtual Private Networks (VPNs), February 2006, available at https://tools.ietf.org/html/rfc4364, describes a method by which a Service Provider (SP) can use its Internet Protocol (IP) backbone to provide an IP Virtual Private Network (VPN) service to customers. In such service, Customer's Edge (CE) routers are connected to Provider's Edge (PE) routers. A CE router exchanges address prefixes, or routes, with a PE router using an agreed routing protocol.

Open Shortest Path First (OSPF), including OSPFv2 for IPv4 and OSPFv3 for IPv6, can serve as a Provider/Customer Edge Protocol for Border Gateway Protocol/Multi-Protocol Label Switching (BGP/MPLS) IP VPNs, referring to RFC 4577, OSPF as the Provider/Customer Edge Protocol for BGP/MPLS IP Virtual Private Networks (VPNs), June 2006, available at https://tools.ietf.org/html/rfc4577. When the OSPF protocol is used on a PE-CE link that belongs to a particular VPN, the PE router will redistribute routes that have been installed in its BGP routing table to the OSPF domain. Similarly, the PE router will redistribute routes that have been installed in its OSPF routing tables to the BGP domain.

However, this may create a problem of routing loop. FIG. 1 shows an exemplary network deployment in which such routing loop may occur. As shown, a PE router, PE1, may learn a route to a particular VPN-IPv4/VPN-IPv6 address prefix N (e.g., 10.0.0.0/8) from another PE router, PE3, via BGP. Then, PE1 may generate a Type-3, Type-5 or Type-7 OSPF Link State Advertisement (LSA) to report the address prefix N to a CE router, CE1. The LSA may be redistributed to another CE router, CE2, possibly through one or more OSPF areas (although CE1 and CE2 are shown as belonging to one single area, Area 1, in FIG. 1), and then to another PE router, PE2. If PE2 leaks N into the BGP domain as a VPN-IPv4/VPN-IPv6 route, then a routing loop would be created.

Section 4.2.5 of RFC 4577 describes two schemes to solve this routing loop issue. In a first scheme, a Downward bit or DN-bit is introduced and a Type-3, Type-5 or Type-7 LSA can carry a set DN-bit in its LSA Option field to indicate that a particular address prefix is learned from a PE router and any other PE router receiving an LSA with the set DN-bit shall ignore the address prefix in the LSA, i.e., not to use the address prefix for route calculation or redistribute it. In the example shown in FIG. 1, PE1 can set the DN-bit in the LSA sent to CE1. The LSA is then redistributed to CE2 and to PE2, with the set DN-bit. Accordingly, upon receiving the LSA with the set DN-bit, PE2 will not use the address prefix for route calculation or redistribute it to the BGP domain. In this way, the address prefix will not be leaked back into the BGP domain. In a second scheme, in order to provide backward compatibility, an OSPF route tag is used for Type-5 and Type-7 LSAs to avoid loops, referring to Sections 4.2.5.2 of RFC 4577.

### SUMMARY

It is an object of the present disclosure to provide a method and a router for translation of LSA, capable of avoiding routing loops.

According to a first aspect of the present disclosure, a method in a CE router for translation of LSA is provided. The CE router is provided at a border of an OSPF Not-So-Stubby Area (NSSA). The method includes: receiving from a PE router a Type-7 LSA containing an address prefix and an LSA option set to prevent any other PE routers receiving the address prefix from using it for route calculation; translating the Type-7 LSA into a Type-5 LSA and setting the LSA option in the Type-5 LSA; and transmitting the Type-5 LSA to a first router external to the NSSA.

In an embodiment, the LSA option can be a DN-bit.

In an embodiment, the first router can be a CE or PE router in an OSPF non-NSSA.

In an embodiment, the OSPF non-NSSA can include an OSPF Area 0.

In an embodiment, the address prefix can be associated with a BGP/MPLS IP VPN.

According to a second aspect of the present disclosure, a CE router is provided. The CE router includes a processor and a memory. The memory includes instructions executable by the processor whereby the CE router is operative to perform the method according to the above first aspect.

According to a third aspect of the present disclosure, a computer readable storage medium is provided. The computer readable storage medium has computer program instructions stored thereon. The computer program instructions, when executed by a processor in a router, cause the CE router to perform the method according to the above first aspect.

With the embodiments of the present disclosure, upon receiving a Type-7 LSA containing an address prefix and an LSA option set to prevent any other PE routers receiving the address prefix from using it for route calculation, a CE router at an NSSA border can translate the Type-7 LSA into a Type-5 LSA, set the LSA option in the Type-5 LSA and transmit the Type-5 LSA to a router external to the NSSA. In this way, the CE router at the NSSA border can propagate the set status of the LSA option beyond the NSSA, so as to avoid the above routing loop problem.

### BRIEF DESCRIPTION OF THE DRAWINGS

The above and other objects, features and advantages will be more apparent from the following description of embodiments with reference to the figures, in which:

FIG. 1 is a schematic diagram showing an exemplary network deployment in which a routing loop may occur;

FIG. 2 is a schematic diagram showing another exemplary network deployment in which a routing loop may occur as a status of an LSA option is lost in LSA translation at a CE router at an NSSA border;

FIG. 3 is a flowchart illustrating a method for translation of LSA according to an embodiment of the present disclosure;

FIG. 4 is a block diagram of a CE router according to an embodiment of the present disclosure; and

FIG. 5 is a block diagram of a CE router according to another embodiment of the present disclosure.

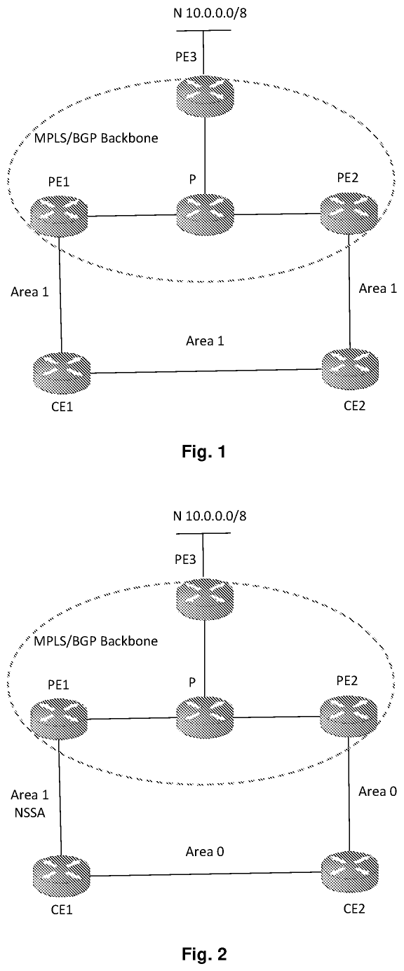

### DETAILED DESCRIPTION

In the following, references in the specification to “one embodiment”, “an embodiment”, “an example embodiment” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

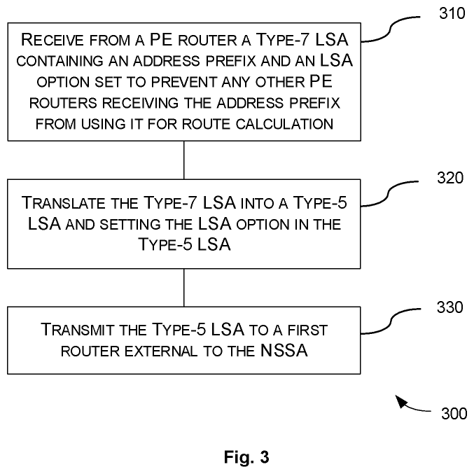

As discussed above, either a DN-bit or a route tag can be used to avoid a routing loop. When the route tag is disabled or not supported, the DN-bit would be the only feasible scheme. FIG. 2 is a schematic diagram showing another exemplary network deployment in which the DN-bit scheme may fail and thus a routing loop may occur. As shown, a PE router, PE1, learns a route to a particular VPN-IPv4/VPN-IPv6 address prefix N (e.g., 10.0.0.0/8) from another PE router, PE3, via BGP. Then, PE1 generates a Type-7 LSA to report the address prefix N to a CE router, CE1. As described above, PE1 sets a DN-bit in the Type-7 LSA for routing loop avoidance. Here, CE1 is a CE router at an NSSA border, i.e., a border between an NSSA (e.g., Area 1) and a non-NSSA (e.g., Area 0). The NSSA is described in RFC 3101, The OSPF Not-So-Stubby Area (NSSA) Option, January 2003, available at https://tools.ietf.org/html/rfc3101. The Type-7 LSA is a local area LSA and thus CE1 needs to translate the Type-7 LSA into a Type-5 LSA, according to Section 3.2 of RFC 3101, for redistribution to another CE router, CE2, in Area 0. During the translation, the set status of the DN-bit is lost and the Type-5 LSA sent from CE1 contains an unset DN-bit. The Type-5 LSA is then redistributed to CE2 and to PE2, with the unset DN-bit. Accordingly, upon receiving the LSA with the unset DN-bit, PE2 will use the address prefix for route calculation and redistribute it to the BGP domain. As a result, a routing loop would be created.

FIG. 3 is a flowchart illustrating a method 300 for translation of LSA according to an embodiment of the present disclosure. The method 300 can be performed at a CE router provided at a border of an OSPF NSSA, e.g., CE1 in FIG. 2.

At block 310, a Type-7 LSA is received from a PE router. The Type-7 LSA contains an address prefix and an LSA option set to prevent any other PE routers receiving the address prefix from using it for route calculation.

For example, the LSA option can be a DN-bit as described above. The address prefix can be associated with a BGP/MPLS IP VPN.

At block 320, the Type-7 LSA is translated into a Type-5 LSA and the LSA option (e.g., DN-bit) in the Type-5 LSA is set.

At block 330, the Type-5 LSA is transmitted to a first router external to the NSSA.

For example, the first router can be a CE or PE router in an OSPF non-NSSA. The OSPF non-NSSA comprises an OSPF Area 0.

With the above method 300, in the example shown in FIG. 2, when receiving the Type-7 LSA containing the set DN-bit from PE1, CE1 translates it into a Type-5 LSA and sets the DN-bit in the Type-5 LSA before redistributing it to CE2 and then to PE2. Accordingly, upon receiving the LSA with the set DN-bit, PE2 will not use the address prefix for route calculation and thus will not redistribute it to the BGP domain. In other words, with the method 300, CE1 can propagate the set status of the DN-bit beyond the NSSA, thereby avoiding the routing loop.

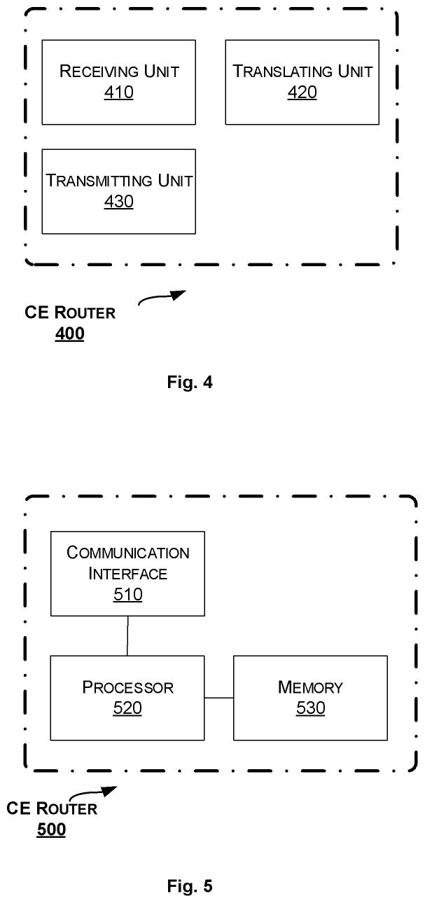

Correspondingly to the method 300 as described above, a CE router is provided. FIG. 4 is a block diagram of a CE router 400 according to an embodiment of the present disclosure. The CE router 400 can be a CE router provided at a border of an OSPF NSSA, e.g., CE1 in FIG. 2.

As shown in FIG. 4, the CE router 400 includes a receiving unit 410 configured to receiving from a PE router a Type-7 LSA containing an address prefix and an LSA option set to prevent any other PE routers receiving the address prefix from using it for route calculation. The CE router 400 further includes a translating unit 420 configured to translate the Type-7 LSA into a Type-5 LSA and set the LSA option in the Type-5 LSA. The CE router 400 further includes a transmitting unit 430 configured to transmit the Type-5 LSA to a first router external to the NSSA.

In an embodiment, the LSA option can be a DN-bit.

In an embodiment, the first router can be a CE or PE router in an OSPF non-NSSA.

In an embodiment, the OSPF non-NSSA can include an OSPF Area 0.

In an embodiment, the address prefix can be associated with a BGP/MPLS IP VPN.

The units 410˜430 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3.

FIG. 5 is a block diagram of a CE router 500 according to another embodiment of the present disclosure. The CE router 500 can be a CE router provided at a border of an OSPF NSSA, e.g., CE1 in FIG. 2.

The CE router 500 includes a communication interface 510, a processor 520 and a memory 530. The memory 530 contains instructions executable by the processor 520 whereby the CE router 500 is operative to perform the actions, e.g., of the procedure described earlier in conjunction with FIG. 3. Particularly, the memory 530 contains instructions executable by the processor 520 whereby the CE router 500 is operative to: receive from a PE router a Type-7 LSA containing an address prefix and an LSA option set to prevent any other PE routers receiving the address prefix from using it for route calculation; translate the Type-7 LSA into a Type-5 LSA and setting the LSA option in the Type-5 LSA; and transmit the Type-5 LSA to a first router external to the NSSA.

In an embodiment, the LSA option can be a DN-bit.

In an embodiment, the first router can be a CE or PE router in an OSPF non-NSSA.

In an embodiment, the OSPF non-NSSA can include an OSPF Area 0.

In an embodiment, the address prefix can be associated with a BGP/MPLS IP VPN.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 520 causes the CE router 500 to perform the actions, e.g., of the procedure described earlier in conjunction with FIG. 3.

The computer program product may be configured as a computer program code structured in computer program modules. The computer program modules could essentially perform the actions of the flow illustrated in FIG. 3.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a Customer's Edge, CE, router for translation of Link State Advertisement, LSA, the CE router being provided at a border of an Open Shortest Path First, OSPF, Not-So-Stubby Area, NSSA, the method comprising:
receiving from a Provider's Edge, PE, router a Type-7 LSA containing an address prefix and an LSA option set to prevent any other PE routers receiving the address prefix from using it for route calculation;
translating the Type-7 LSA into a Type-5 LSA and setting the LSA option in the Type-5 LSA; and
transmitting the Type-5 LSA to a first router external to the NSSA.

2. The method of claim 1, wherein the LSA option is a DN-bit.

3. The method of claim 1, wherein the first router is a CE or PE router in an OSPF non-NSSA.

4. The method of claim 3, wherein the OSPF non-NSSA comprises an OSPF Area 0.

5. The method of claim 1, wherein the address prefix is associated with a Border Gateway Protocol/Multi-Protocol Label Switching Internet Protocol Virtual Private Network, BGP/MPLS IP VPN.

6. A Customer's Edge, CE, router for translation of Link State Advertisement, LSA, the CE router being provided at a border of an Open Shortest Path First, OSPF, Not-So-Stubby Area, NSSA, the CE router comprising a processor and a memory, the memory comprising instructions executable by the processor whereby the CE router is operative to:
receive from a Provider's Edge, PE, router a Type-7 LSA containing an address prefix and an LSA option set to prevent any other PE routers receiving the address prefix from using it for route calculation;
translate the Type-7 LSA into a Type-5 LSA and setting the LSA option in the Type-5 LSA; and
transmit the Type-5 LSA to a first router external to the NSSA.

7. A computer readable storage medium having computer program instructions stored thereon, the computer program instructions, when executed by a processor in a Customer's Edge, CE, router, causing the CE router to perform the method according to claim 1.

8. The CE router of claim 6, wherein the LSA option is a DN-bit.

9. The CE router of claim 6, wherein the first router is a CE or PE router in an OSPF non-NSSA.

10. The CE router of claim 6, wherein the OSPF non-NSSA comprises an OSPF Area 0.

11. The CE router of claim 6, wherein the address prefix is associated with a Border Gateway Protocol/Multi-Protocol Label Switching Internet Protocol Virtual Private Network, BGP/MPLS IP VPN.
